(19) United States
(12) Patent Application Publication
(10) Pub. No.: US 2008/0041199 A1
(43) Pub. Date: Feb. 21, 2008

(54) Insertion type hand tool

(76) Inventor: Chih-Ching Hsieh, Taichung City (TW)

Correspondence Address: Chih-Ching Hsieh, 235 Chung - Ho, Box 8-24, Taipei, TW

(21) Appl. No.: 11/397,950

(22) Filed: Apr. 5, 2006

(51) Int. Cl. B25G 1/00

(52) U.S. Cl. 81/489

(57) ABSTRACT

An insertion type hand tool comprises a tool body having a handle; one end of the handle having a receiving groove; a connecting portion pivotally installed in the receiving groove; a lower end of the connecting portion being formed with a teethed portion; a resisting unit installed in the receiving groove; one end of the resisting unit having a teeth surface engageable to the teethed portion of the resisting unit; a lower end of the receiving groove having an adjusting unit for adjusting the resisting unit to extend so as to engage with connecting portion or to reduce so as to release from the connecting portion. The adjusting unit has an adjusting rod and an elastic unit; the adjusting rod has a recess; when the adjusting unit is pressed, the recess receives the resisting unit so that the resisting unit is released from the connecting portion.

### FIELD OF THE INVENTION

The present invention relates to hand tools, and in particular to an insertion type hand tool, wherein a connecting portion is pivotally installed to a handle and a driving portion is adjustably installed to the connecting portion so that the driving portion can be adjusted in two directions.

### BACKGROUND OF THE INVENTION

In the prior art, the handle and the head of a hand tool are arranged at the same plane and the handle is non-rotatable with respect to the head so that the orientation of the head with respect to the handle is unadjustable. However if the work environment is not so suitable for locating the hand tool, the hand tool cannot be operated conveniently.

Therefore, in one improvement, the head is folded with respect to the handle with a predetermined angle. However the bending angle between the handle and the head is fixed, Thus it is only suitable for some specific work environments.

Thus there are other hand tools being developed for overcoming the defect in the prior art designs, however all these hand tools can only make the head pivotally rotates with respect to the handle in one orientation, but it cannot rotate along a different orientation. Thereby the head is fixedly installed to the handle. It is un-replaceable. Thus if the driven object (for example a screw) is not suitable for the hand tool, another kind of the hand tool must be prepared. Thus the use of the prior art is limited.

### SUMMARY OF THE INVENTION

Accordingly, the primary object of the present invention is to provide an insertion type hand tool, wherein a connecting portion is pivotally installed to a handle and a driving portion is adjustably installed to the connecting portion so that the driving portion can be adjusted in two directions.

To achieve above objects, the present invention provides an insertion type hand tool which comprises a tool body having a handle; one end of the handle having a receiving a groove; a connecting portion pivotally installed in the receiving groove; a lower end of the connecting portion being formed with a teethed portion; a resisting unit installed in the receiving groove; one end of the resisting unit having a teeth surface engageable to the teethed portion of the resisting unit; a lower end of the receiving groove having an adjusting unit for adjusting the resisting unit to extend to engage with connecting portion or to reduce to release from the connecting portion. The adjusting unit has an adjusting rod and an elastic unit; the adjusting rod has a recess; when the adjusting unit is pressed, the recess receives the resisting unit so that the resisting unit is released from the connecting portion.

The various objects and advantages of the present invention will be more readily understood from the following detailed description when read in conjunction with the appended drawing.

### BRIEF DESCRIPTION OF THE DRAWINGS

FIG. 1 is an exploded perspective view of the insertion type hand tool of the present invention.

FIG. 2 is a perspective view of the insertion type hand tool of the present invention.

FIG. 3 is an assembled cross sectional view of the insertion type hand tool of the present invention.

FIG. 4 is a schematic cross sectional view of the insertion type hand tool of the present invention.

FIGS. 5 to 7 are cross sectional views showing the adjustment of the insertion type hand tool of the present invention.

FIG. 8 is a schematic cross sectional view of the second embodiment of the present invention.

FIGS. 9 to 11 are cross sectional views showing the adjustment of the insertion type hand tool in the second embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

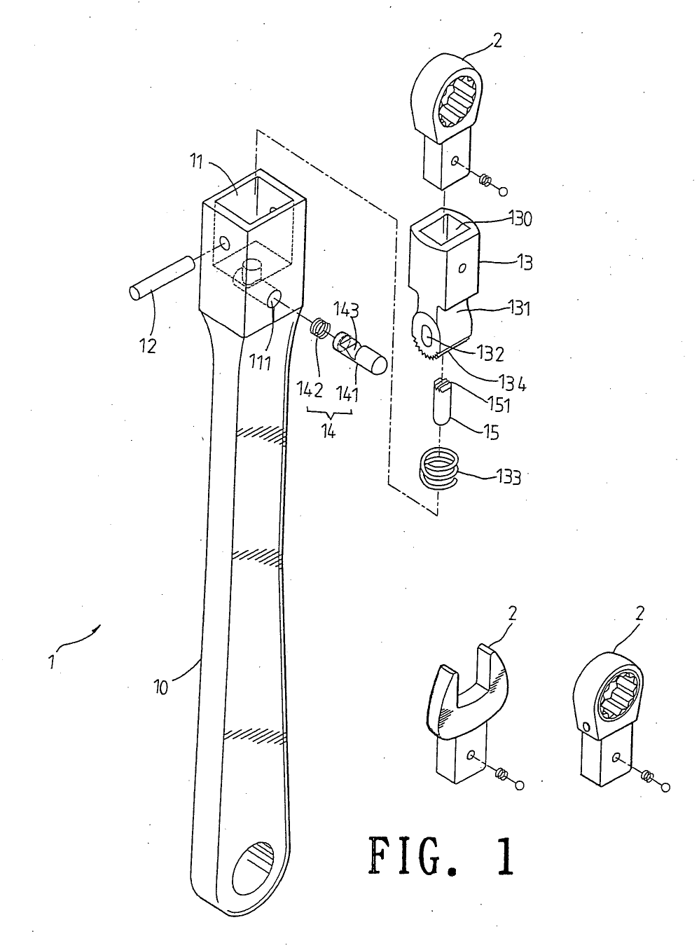

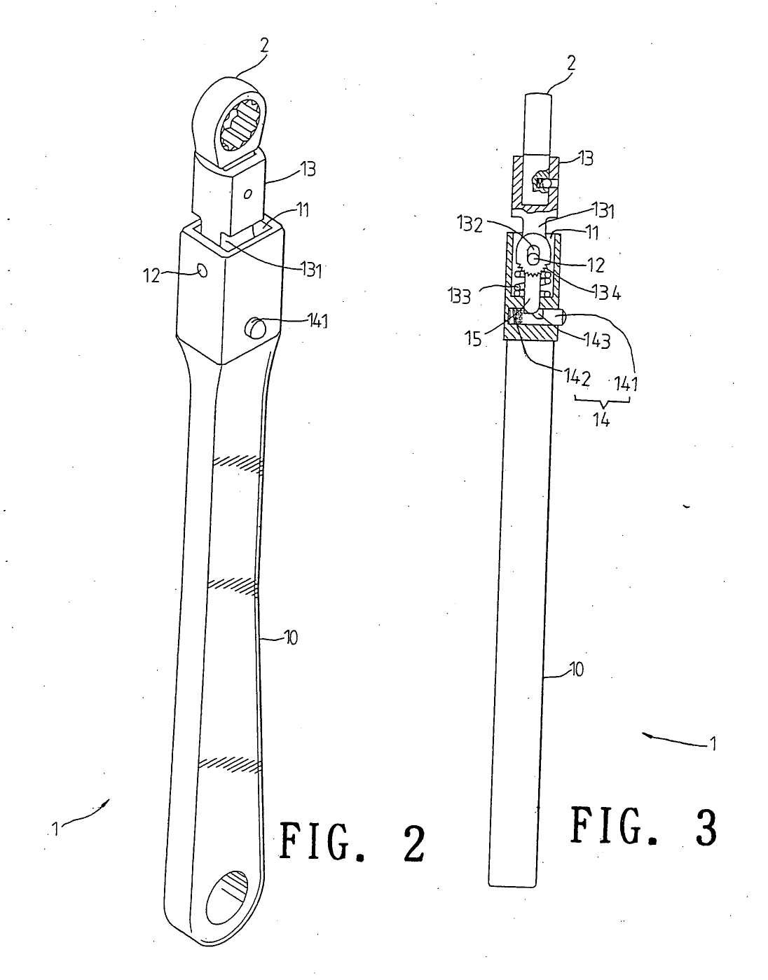

Referring to FIGS. 1 to 3, the present invention is illustrated. The present invention mainly includes a tool body 1 and a plurality of driving portions 2 which may have a form of a ring driving portion, an open ended driving portion, or a ratchet wheel driving portion, etc. The present invention has the following elements.

The tool body 1 has a handle 10. One end of the handle 10 is pivotally installed with a receiving groove 1. A resisting unit 15 is installed in the receiving groove 11.

A connecting portion 13 is connected to the receiving groove 11. The connecting portion 13 is rotatably connected to the tool body 1. A bottom of the receiving groove 11 is installed with an adjusting unit 14. The receiving groove 11 serves to resist against and position the connecting portion 13.

A driving portion 2 is included.

The connecting portion 13 has an inserting opening 130 for receiving the driving portion 2. A lower end of the connecting portion 13 is formed with a neck 131. The neck 131 is installed with an elliptical pivotal hole 132 for receiving a pivotal shaft 12. A cross section of the neck 131 is smaller than a size of an opening of the receiving groove 11 so that the connecting portion 13 is rotatable in the receiving groove 11. A resisting unit 15 has a teethed upper surface. A lower end of the neck 131 has a teethed portion 134 which is engaged to the teethed upper surface of the resisting unit 15. A spring 133 is located below the neck 131 and encloses the resisting unit 15 so as to position the connecting portion 13.

A bottom of the receiving groove 11 has a receiving hole 111 for installing an adjusting unit 14. The adjusting unit 14 serves to interact with and contact the resisting unit 15. The adjusting unit 14 includes an adjusting rod 141 and an elastic unit 142. The adjusting rod 141 is installed at a lower end of the receiving groove 11 and is resisted by the elastic unit 142 to protrude from the receiving groove 11. The adjusting rod 141 has a recess 143. The adjusting rod 141 serves to control the telescopic movement of the resisting unit 15.

In assembly of the present invention, the elastic unit 142 of the adjusting unit 14 is placed into the receiving hole 111 of the receiving groove 11 and the adjusting rod 141 is placed in the receiving hole 111. The adjusting rod 141 is resisted by the elastic unit 142 to protrude out of the receiving groove 11. The spring 133 and the resisting unit 15 are installed in the receiving groove 11. Then the neck 131 of the connecting portion 13 is placed into the receiving groove 11. The pivotal shaft 12 passes through the pivotal hole 132 of the neck 131 so that the connecting portion 13 is pivotally installed to the receiving groove 11. The teethed portion 134 of the connecting portion 13 is engaged to the teethed surface 151 of the resisting unit 15.

Referring to FIG. 3, when the adjusting unit 14 of the present invention is not pressed, the adjusting unit 14 extends out slightly due to the resisting action of the elastic unit 142. Then the adjusting rod 141 resists against the resisting unit 15. The resisting unit 15 cannot reduce inwards so that the teethed surface 141 at the upper side of the resisting unit 15 is engaged to the teethed portion 134 of the connecting portion 13. The connecting portion 13 cannot rotate.

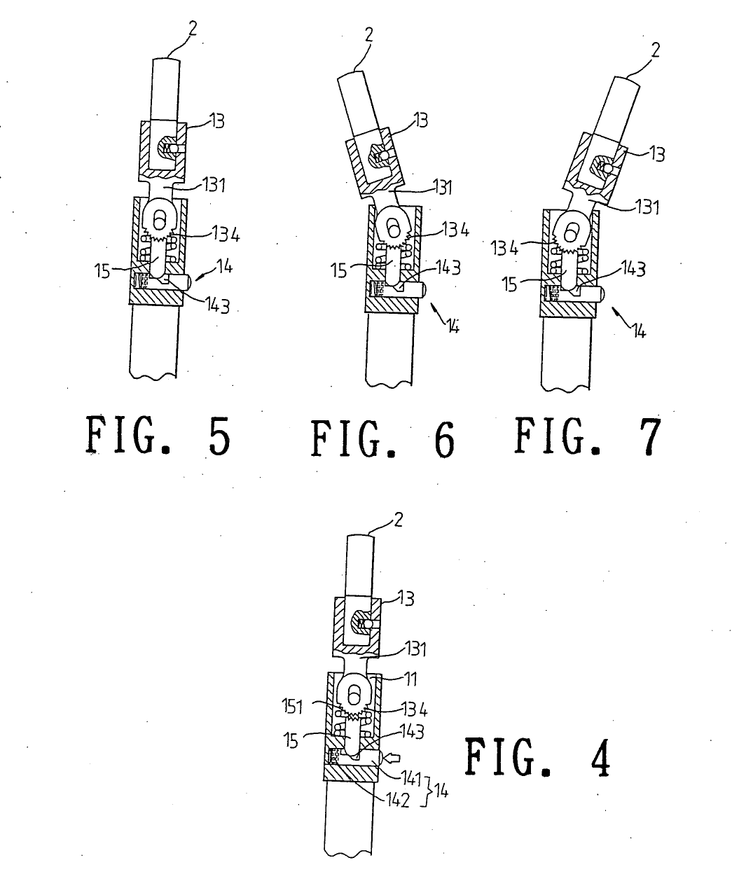

Referring to FIGS. 4 to 7, if it is desired to adjust the connecting portion 13 to change the orientation thereof, the adjusting rod 141 of the spring 133 is pressed firstly so that the adjusting rod 141 and the elastic unit 142 reduces inwards. Thereby the recess 143 of the adjusting rod 141 is corresponding to one end of the resisting unit 15 so that the resisting unit 15 is retracted to a reducing space. The teethed surface 151 of the resisting unit 15 separates from the teethed portion 134 of the connecting portion 13. The connecting portion 13 is not confined so that it is rotatable. When it is adjusted to a desired orientation, the adjusting unit 14 is released so that the elastic unit 142 resists the adjusting rod 141 to return to the original position. as shown in FIGS. 5 to 7, the connecting portion 13 resists against the resisting unit 15 to be positioned in a desired position.

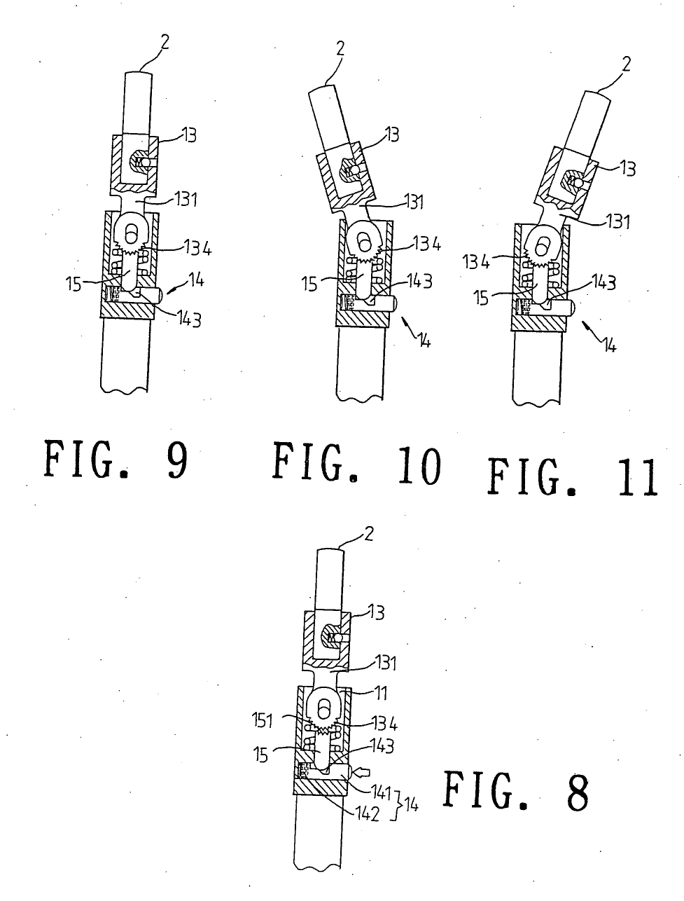

With reference to FIGS. 8 to 11, the second embodiment of the present invention is illustrated. Those identical to the first embodiment will not be described. Only those differences are described.

In FIG. 8, it is illustrated that the adjusting unit 14 can have a form of a nut. The nut resists against the resisting unit 15. By rotating the nut, the extension and reducing of the resisting unit 15 is controllable so as to control the resisting unit 15 to resist against the connecting portion 13 or released from the connecting portion 13.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An insertion type hand tool comprising:
a tool body having a handle; one end of the handle having a receiving groove;
a connecting portion pivotally installed in the receiving groove; a lower end of the connecting portion being formed with a teethed portion;
a resisting unit installed in the receiving groove; one end of the resisting unit having a teeth surface engageable to the teethed portion of the resisting unit; a lower end of the receiving groove having an adjusting unit for adjusting the resisting unit to protrude out so as to engage with connecting portion or to reduce to release from the connecting portion.

2. The insertion type tool as claimed in claim 1, wherein the connecting portion has an inserting opening for receiving a driving portion.

3. The insertion type tool as claimed in claim 1, wherein the adjusting unit has an adjusting rod and an elastic unit; the adjusting rod has a recess; when the adjusting unit is pressed, the recess receives the resisting unit so that the resisting unit is released from the connecting portion.

4. The insertion type tool as claimed in claim 1, wherein the adjusting unit is a nut which is screwed to the resisting unit; when the nut is screwed, the resisting unit will be adjusted to engage the connecting portion or to release from the connecting portion.

5. The insertion type tool as claimed in claim 1, wherein a lower end of the connecting portion has a neck; the neck has a pivotal hole; a pivotal shaft passes through the pivotal hole so that the neck is pivotally installed in the receiving groove; and thus, the neck is rotatable with respect to the handle.

6. The insertion type tool as claimed in claim 5, wherein the pivotal hole has an elliptical shape and a spring is located below the neck and encloses the resisting unit so as to position the connecting portion.
